(19) United States
(12) Patent Application Publication
(10) Pub. No.: US 2004/0185194 A1
(43) Pub. Date: Sep. 23, 2004

(54) Ink-jet recording sheet

(75) Inventors: Masako Kikuchi, Tokyo (JP); Kiyoshi Endo, Kaisei-machi (JP); Tomohiko Sakai, Tokyo (JP); Takayuki Suzuki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/795,156

(22) Filed: Mar. 5, 2004

(30) Foreign Application Priority Data
Mar. 20, 2003 (JP) JP2003-077665
Mar. 25, 2003 (JP) JP2003-081959

(51) Int. Cl. B41M 5/00

(52) U.S. Cl. 428/32.32; 428/32.2

(57) ABSTRACT

An ink-jet recording sheet comprising a support having thereon an ink receptive layer containing silica microparticles and a water-soluble resin, wherein the ink receptive layer is a porous layer having ink receptive voids with a peak value in a distribution curve of radii of the ink receptive voids of 10 to 50 nm; and the silica microparticles are prepared by pulverizing a silica powder, two parameters X and Y of the silica microparticles satisfying the following relationship: 150<Y+17×logₑ (X)<500, X being a number of silica microparticles having a diameter of not less than 10 μm contained per gram of the silica microparticles; and Y being an average particle diameter of the silica microparticles measured in nm.

### TECHNICAL FIELD

The present invention relates to an ink-jet recording sheet (hereinafter, also simply referred to as a recording sheet), and particularly to an ink-jet recording sheet which exhibits an excellent ink absorptive property, a high printing density as well as a high gloss.

### BACKGROUND

Ink-jet recording performs recording of such as images and/or characters by flying minute ink droplets based on various operation principles to be adhered on a recording sheet such as paper, and is prevailing in recent years, since it is provided with advantages of achieving relatively easily a higher speed, a lower noise and multi-color. On the other hand, it has come to be utilized as a so-called photo-like recording sheet in a high quality printing such as photography, and a large ink absorption amount, a high absorption rate, a high printing density and high gloss have been required as a recording sheet.

To solve these problems, heretofore, many techniques have been proposed. Among them, one of the most extensively investigated is a recording sheet having a porous ink receiving layer. A recording sheet having a porous ink receiving layer is also referred to as a porous type recording sheet. For example, there is proposed to provide micro-voids having a peak at 0.2-10 μm on the surface of an ink receptive layer to increase an ink absorption rate as disclosed in Japanese Examined Patent Publication No. 63-22977. For this purpose, the pigment itself or the secondary particle has to be made large in size. Therefore, smoothness of the surface is hardly obtained and light transmittance becomes poor, which makes it impossible to achieve a high gloss similar to that of silver salt photography. Further, since ink reaches as far as the bottom of an ink receptive layer, high densities cannot be obtained.

To achieve gloss, recently proposed are various techniques in which an ink receptive layer is constituted of two or more layers and the upper layer is made to be a gloss exhibiting layer (refer to such as JP-A Nos. 3-215080, 3-256785, 7-89220, 7-101142, 7-117335 and 9-183267 (Hereinafter, JP-A refers to Japanese Patent Publication Open to Public Inspection)). As the primary component of these gloss exhibiting layer, employed is colloidal silica or a complex compound of colloidal silica. A gloss exhibiting layer generally utilized is prepared by a casting process. These methods are poor in an ink absorption rate.

For the purpose of providing an ink-jet recording sheet having a high gloss, an excellent coloration, water resistance and a high printing density, as well as an excellent ink absorptive property and high definition, proposed has been an ink-jet recording sheet in which at least one of the ink receptive layers contains silica microparticles, comprising secondary particles having an average particle diameter of 10-150 nm made of agglomerated primary particles having a particle diameter of 3-40 nm, and a water-soluble resin, in addition to this, a peak of the distribution curve of surface micro-void radii of said layer is practically not more than 40 nm (refer to Patent Literature 1).

A porous type recording sheet is usually produced by a method of: (i) coating an aqueous coating composition on a support; and then (ii) drying. When the thickness of wet coating layer is too large, the layer tends to produce cracking, or takes long time to be dried. In such case, the productivity of the recording sheet can be improved by increasing the density of solid portion in the aqueous coating composition so as to decrease the wet thickness of coated layer and to avoid the cracking of the layer after drying.

There have been proposed many techniques to increase the density of solid portion in the aqueous coating composition in order to improve the productivity. One of the examples is to control the pH vale of the aqueous coating composition. This enables to coat a layer having high content of silica with a thin layer. The technology is disclosed in Patent Literature 2. Another example to improve the productivity is disclosed in Patent Literature 3. The technology is to control the time between completion of dispersion of solid microparticles and beginning of coating the coating composition. However, these technologies are still to be improved so as to obtain a sufficient effect.

[Patent Literature 1] JP-A No. 10-71764

[Patent Literature 2] JP-A No. 2000-211241 (page 2, lines 2 to 4)

[Patent Literature 3] JP-A No. 2001-149856 (page 2, lines 2 to 4)

In patent literature 1, proposed is a method in which an average particle diameter of silica and the micro-void diameter in an ink receptive layer are specified to make the gloss, density and ink absorption property to be consistent, however, the ink absorption rate is insufficient due to the average particle diameter of the silica employed in this method as small as not more than 150 nm.

This invention has been made in view of these situations, and the objective is to provide an ink-jet recording sheet exhibiting an excellent ink absorptive property, a high printing density and a high gloss.

### SUMMARY

The above objective can be achieved by the following means.

1. An ink-jet recording sheet comprising a support having thereon an ink receptive layer containing silica microparticles and a water-soluble resin,

wherein the ink receptive layer is a porous layer having ink receptive voids with a peak value in a distribution curve of radii of the ink receptive voids of 10 to 50 nm; and the silica microparticles are prepared by pulverizing a silica powder, two parameters X and Y of the silica microparticles satisfying the following relationship:

150<Y+17×logₑ(X)<500,

X being a number of silica microparticles having a diameter of not less than 10 μm contained per gram of the silica microparticles; and

Y being an average particle diameter of the silica microparticles measured in nm.

2. The ink-jet recording sheet of Item 1, wherein the silica powder has a pore volume of not less than 0.2 ml/g, the pore volume being defined as a sum of volumes of pores in the silica powder, each pore having a diameter of not more than 10 nm.

3. The ink-jet recording sheet of Item 1, wherein a specific surface area of the silica powder is not less than 200 m²/g, and a total volume of the ink receptive voids in the ink receptive layer is not less than 15 ml/m².

4. The ink-jet recording sheet of Item 1, wherein the silica microparticles has a ratio of isolated silanol groups of less than 1.0.

5. The ink-jet recording sheet of Item 4, wherein an average particle diameter of primary particles of the silica microparticles is 120 to 350 nm.

6. The ink-jet recording sheet of Item 4, wherein the silica microparticles are made by a wet method; a specific surface area of the silica microparticles measured with a BET method is 150 to 350 m²/g; and an average particle diameter of secondary particles of the silica microparticles measured with a Coulter counter is 1.0 to 2.8 μm.

7. The ink-jet recording sheet of Item 4, wherein a surface glossiness of the ink-jet recording sheet measured at 75 degree is 45 to 80%.

8. The ink-jet recording sheet of Item 7, wherein the ink receptive layer is prepared using a method comprising the step of:

coating an ink receptive coating composition on the support to form the ink receptive layer; and

drying the coated ink receptive layer without a post-treatment so as to increase a surface glossiness.

9. A method of preparing an ink-jet recording sheet of Item 1, comprising the steps of:

(i) dispersing the silica microparticles and an aqueous media to obtain a silica dispersion;

(ii) adding an additive to the silica dispersion to make a coating composition;

(iii) coating the coating composition onto a support; to obtain an ink receptive layer; and

(iv) drying the ink receptive layer,

wherein the step (i) comprises:

(i-1) a first dispersing step to obtain a preliminary silica dispersion; and

(i-2) a second dispersing step to obtain the silica dispersion by further dispersing the preliminary silica dispersion.

10. The preparation method of Item 9, wherein the first dispersing step (i-1) is conducted by:

continuously introducing the silica microparticles and an aqueous media into a first dispersing apparatus and dispersing so as to obtain a preliminary silica dispersion; and

continuously ejecting the preliminary silica dispersion from the first dispersing apparatus,

the second dispersing step (i-2) is conducted by:

continuously introducing the preliminary silica dispersion into a second dispersing apparatus so as to further disperse the preliminary silica dispersion; and

continuously ejecting the silica dispersion from the second dispersing apparatus.

11. A method of preparing an ink-jet recording sheet of Item 1, wherein an average particle diameter of the silica microparticles is 120 to 350 nm.

12. A method of preparing an ink-jet recording sheet of Item 1, wherein the silica microparticles have a specific surface area measured with a BET method of 150 to 350 m²/g and an average particle diameter of secondary particles of the silica microparticles is 1.0 to 2.8 μm measured with a Coulter counter.

13. A method of preparing an ink-jet recording sheet of Item 1, wherein a surface glossiness of the ink-jet recording sheet measured at 75 degree is 45 to 80%.

14. A method of preparing an ink-jet recording sheet of Item 1, wherein in the drying step (iv), drying the ink receptive layer is carried out without a post-treatment which increases a surface glossiness of the ink-jet recording sheet.

### BRIEF DESCRIPTION OF THE DRAWING

FIG. 1 is a schematic diagram of an FT-IR absorption chart of silica.

### DESCRIPTION OF THE PREFERRED EMBODIMENTS

The embodiments of this invention will be detailed in the following.

An ink-jet recording sheet according to this invention can exhibit an excellent ink absorptive property, a high printing density and a high surface glossiness, by adjusting a sum volume of micro pores having a diameter of not more than 10 nm of a silica powder having inner pores, an average particle diameter of silica microparticles prepared by pulverize-dispersing said silica powder, a number of coarse particles therein and the void diameter in an ink receptive layer.

A diameter of a silica particle and a diameter of a silica powder, and a radius of an ink receptive void each indicate respectively a diameter of a sphere having the equivalent volume of the silica particle, the silica powder or the ink receptive void to be measured.

Amorphous silica is preferably utilized as silica.

Amorphous silica is preferably silica synthesized by an ordinary wet-method (wet-method silica) and silica synthesized by a gas-phase method (gas-phase method silica), and among them specifically preferred is wet-method silica.

Silica powders made by a wet-method according to this invention can be prepared by commonly known manufacturing methods. A typical example of manufacturing methods is as follow: Sulfuric acid is added into a sodium silicate solution containing Na₂SO₄ (a mole ratio of 2.9-3.5, a SiO2 concentration of 3.5-5.5%) to make a neutralization ratio of 40 to 55% while keeping the solution temperature at 20-40° C. Next, the aqueous solution is heated up to 80-95° C. to be ripened for 5-60 minutes and sulfuric acid is added while being stirred until the pH becomes 3-4. Silica thus prepared is pulverized and classified after having been filtered, washed with water and dried.

In this method, a BET specific surface area of a silica powder can be adjusted primarily by a reaction temperature, a SiO₂ concentration, a neutralization ratio and an addition time of sulfuric acid. The pore radius distribution can be adjusted by a Na₂SO₄ concentration, a reaction temperature, a SiO₂ concentration and a neutralization ratio.

Further, products available on the market such as Finesil (manufactured by Tokuyama Corp.) and Nipsil (manufactured by Nippon Silica Industrial Co., Ltd.) can be also utilized.

In silica powders according to this invention, a sum volume of pores having a diameter of not more than 10 nm is preferably not less than 0.2 ml/g. The upper limit is not specified, however, is preferably not more than 1.0 ml/g. Further, a specific surface area is preferably not less than 150 m²/g and the upper limit is preferably not more than 400 m²/g although it is not restricted. Decrease of a printing density results when they are less than said range, while decrease of the absorption rate results when they are more than said range. It is necessary to keep ink on the surface of a receptive layer to increase a printing density, and it has been proved as a result of study, that a sum volume of pores having a diameter of not more than 10 nm is important.

The silica powder prepared by the aforesaid method or silica powders available on the market have a diameter of a few μm. When these are employed as they are in an ink receptive layer, voids are formed and ink absorption rate is high due to the large void size in the receptive layer. However, a rate of ink permeation towards the bottom of an ink receptive layer is faster than the rate of ink absorption by the pores of silica itself. Therefore, appropriately high printing density cannot be obtained. Further, it is impossible to achieve a high surface glossiness due to a large particle diameter of silica itself. Therefore, it is necessary to employ a silica after having been pulverize-dispersed in an aqueous medium to be made into microparticles.

To satisfy an ink absorptive property, a printing density and gloss, it is important to optimize a sum volume of pores of a silica powder itself, a void diameter in an ink receptive layer and a particle diameter of silica microparticles.

A peak value in a distribution curve of radii of micro-voids in an ink receptive layer is preferably 10 to 50 nm. An ink absorption rate is deteriorated when it is less than this range, while a printing density and gloss are deteriorated when it is more than this range. There is also reported that a micro-void diameter and gloss of an ink receptive layer is controlled by particle diameter of silica microparticles. However, it is not sufficient, that is, it has been proved according to our intensive study that the control is difficult only by an average particle diameter of silica microparticles, and the control is ensured by considering a number of silica micropaticles having a diameter of not less than 10 μm. For example, when a number of silica microparticles having a diameter of not less than 10 μm is large although average particle diameter is the same, a micro-void diameter in an ink receptive layer becomes large resulting in decreased gloss. On the contrary, when an average particle diameter is small although a number of silica microparticles having a diameter of not less than 10 μm is large, a micro-void diameter in an ink receptive layer becomes small resulting in high gloss. That is, it has been proved that the balance between an average particle diameter of silica microparticles and a number of silica microparticles having a diameter of not less than 10 μm can control a micro-void diameter and gloss of an ink receptive layer.

In silica microparticles according to this invention, it is important that the relationship between an average particle diameter and a number of silica microparticles having a diameter of not less than 10 μm contained per gram of said silica microparticles satisfies aforesaid equation (1). An average particle diameter of silica microparticles according to this invention is not specifically limited provided being prepared to satisfy aforesaid equation (1), however, is preferably 150-350 nm with respect to such as gloss and cracks as photo-like products.

An ink absorptive property, a printing density and gloss can be satisfied by controlling an average particle diameter and a number of silica microparticles having a diameter of not less than 10 μm, of silica microparticles according to this invention. In many techniques heretofore, gloss has been sought for by decreasing an average particle diameter of silica microparticles, however, according to this invention, it is not necessary to decrease a particle diameter unreasonably and to apply a great energy for the pulverize-dispersion. The control of silica microparticles having a particle diameter of not less 10 μm is possible by being subjected to filtering or centrifugal separation after or during pulverize-dispersion.

A total micro-void volume of an ink receptive layer according to this invention is preferably not less than 15 ml/m² and the upper limit is preferably not more than 30 ml/m² although being not limited. When it is over this value, an ink receptive layer becomes thick to increase coating defects such as cracks. Further, a surface glossiness measured at 75 degree of an ink receptive layer is preferably not less than 45%.

Herein, an average particle diameter of silica microparticles according to this invention is a value measured by use of Photon Correlation Method Zetasizer 1000 HS, produced by Malvern Co., Ltd. A number of silica microparticles having a diameter of not less than 10 μm is a value measured by use of HIAC/ROYCO Model 8000A Particle Counter, produced by Pacific Scientific Co., Ltd. To count a number of silica microparticles having a diameter of not less than 10 μm was performed as follows: a solution containing silica microparticles of 0.25 weight % was prepared by dilution of a silica microparticle dispersion and a number of silica microparticles having a diameter of not less 10 μm in 10 ml of the aforesaid 0.25% solution to calculate a converted value for a number of silica microparticles having a diameter of not less than 10 μm per gram of silica microparticles. The measurement was performed within a range of 2-100 μm and a number of particles larger than 10 μm is designated as a number of silica microparticles having a diameter of not less than 10 μm.

A pore diameter and a micro-void volume, of a silica powder and in an ink receptive layer according to this invention, were measured by use of Micrometrics Pore Analyzer 9320 (produced by Shimazu Corporation). A micro-void diameter and a micro-void volume in an ink receptive layer were determined by measuring micro-void distributions in a support itself and in a support+an ink receptive layer, and a micro-void distribution in an ink receptive layer is determined by eliminating the micro-void distribution of a support itself.

A specific surface area of the silica powder according to this invention was measured by use of a BET type specific surface area detector based on simplified type N₂ adsorption.

To achieve the objective of this invention to improve productivity by increasing a solid concentration of a water-based coating solution, a ratio of an isolated silanol group on the silica surface before dispersion is preferably less than 1.0. Wherein, a ratio of silanol group can be determined by use of FT-IR.

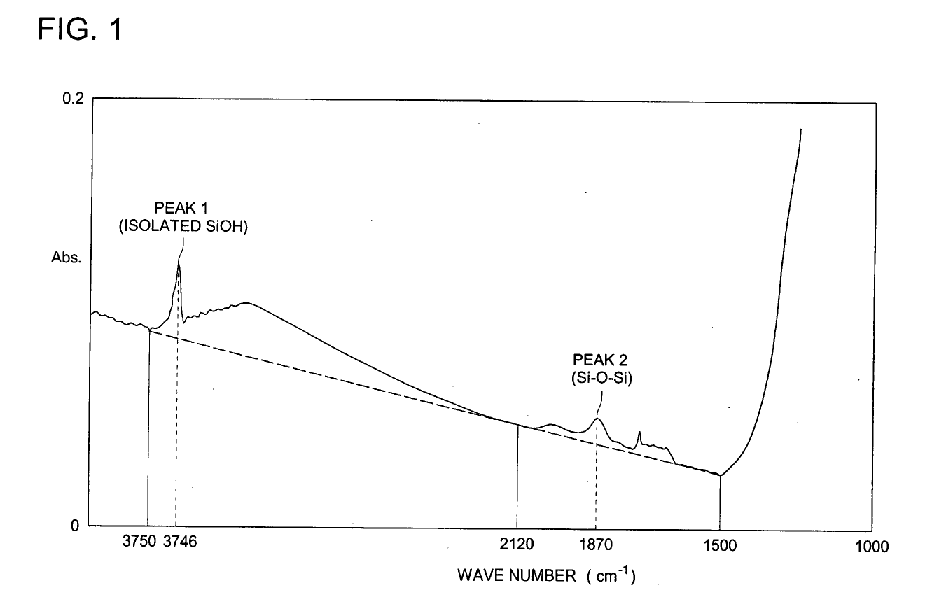

FIG. 1 is a schematic diagram of an FT-IR absorption chart of silica. “Abs.” in FIG. 1 indicates “absorbance”.

Specifically, a silica powder is dried at 120° C. for 24 hours, and a small amount of said dried silica is adhered on a window plate of KRS-5 to perform the measurement. Since an isolated silanol group is apt to react with moisture of KBr when silica is diluted by KBr, the measurement is performed without dilution. An infrared absorption spectrometer (FT-IR-4100, produced by Hitachi Bunko Co., Ltd.) is employed as a measurement apparatus and measurement is performed by a transmission method at 1000-4000 cm⁻¹. Measured are an absorbance at the peak of 3746 cm⁻¹ assigned to an isolated silanol group when being subjected to a base-line treatment by connecting valleys of the both sides, and an absorbance at 1870 cm⁻¹ assigned to a stretching vibration of siloxane making the line which connects the points at a valley near 3750 cm⁻¹, a valley near 2120 cm⁻¹ and a valley near 1500 cm⁻¹ as a base-line. Then, a ratio of an isolated silanol group of this invention (hereinafter also referred to as IR ratio) means a ratio of an absorbance at 3746 cm⁻¹ assigned to Si—OH (a height of Peak 1) to an absorbance at 1870 cm⁻¹ assigned to Si—O—Si (a height of Peak 2), and represented as follows:

Ratio of isolated silanol group=absorbance at 3746 cm⁻¹/absorbance at 1870 cm⁻¹

A ratio of an isolated silanol group according to this invention can be adjusted by such methods as controlling a water content of silica by means of water vapor spray or storing silica at a relative humidity of 20-60% for a long period. A method of spraying water vapor includes a method in which water vapor is continuously sprayed while silica is transferred, and a method in which water vapor is sprayed while silica is charged in a sealed batch and being aerated. Further, a ratio of an isolated silanol group can be also adjusted by increasing a bulk density by a pressing treatment.

A pulverize-dispersion method of a silica powder is not specifically limited, however, is preferably provided with a preliminary dispersion process and a main dispersion process, and a pulverize-dispersed particle diameter at the preliminary dispersion process is preferably not more than 1000 nm. When it is over this size, much time and energy are required for the main dispersion process. Homogenizers employed in a preliminary dispersion process is preferably a continuous type with respect to productivity, and preferable are homogenizers of a roller type, a kneader type, a pin-mixer type and a continuous stirring type. Plural homogenizers may be appropriately employed.

In a continuous method, it is preferable to prepare a preliminary dispersion by pulverize-dispersing silica and a water-based medium while being supplied continuously into a homogenizer and simultaneously ejecting out the dispersion prepared from the homogenizer.

In a main dispersion process, where the average diameter is finally determined, homogenizers preferably employed include a high-pressure homogenizer, a wet-type media pulverizing mill (such as a sand mill and a ball mill), a continuous high-speed stirring homogenizer and an ultrasonic homogenizer. Among them, preferred is a sand mill since it can pulverize-dispersed a preliminary dispersion of a high concentration efficiently in a short period and is effective to control a number of silica microparticles having a diameter of not less than 10 μm. The medium employed in a sand mill is preferably made of zirconia having a size of 0.1-1.0 mm. The circumferential speed is preferably 5-15 m/sec.

The concentration of silica at pulverize-dispersion is preferably 20-50% and more preferably 25-40%, in consideration of productivity and easy handling. The pulverize-dispersed silica micro-particles are preferably subjected to a process to control a number of silica microparticles having a diameter of not less than 10 μm. The methods employed in the control process include such as a method by means of centrifugal separation and a method by means of a filter. As a method by means of centrifugal separation, employed can be Microcut, produced by Kuretech Co., Ltd. Filters include such as Profile, manufactured by Nippon Pole Co., Ltd., and TCPD, manufactured by Advantech Toyo Co., Ltd.

Silica microparticles after having been processed with the aforesaid treatment were mixed with a water-soluble resin and coated on a support, followed by being dried to prepare an ink receptive layer. Silica microparticles after having been mixed with a water-soluble resin are preferably subjected again to a filtering process.

As the aforesaid water-soluble resin, preferably include are at least a cationic polymer or a water-soluble polyvalent metallic compound. Furthermore preferably included is also a hardener.

The aforesaid cationic polymer is preferably a polymer provided with a quaternary ammonium salt, and specifically preferably a homopolymer of a monomer provided with a quaternary ammonium salt or a copolymer thereof with one or more other copolymerizable monomers. Examples of a monomer provided with a quaternary ammonium salt include the following.

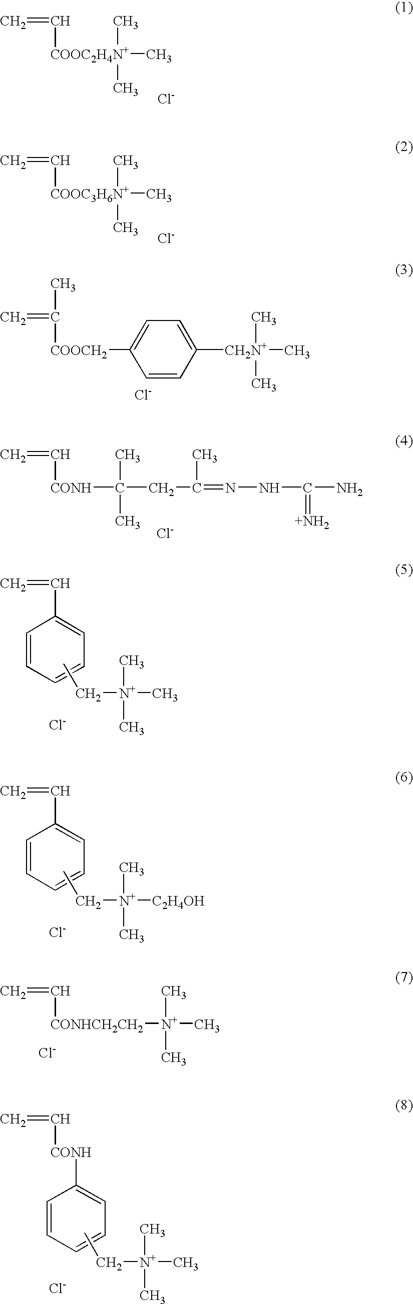

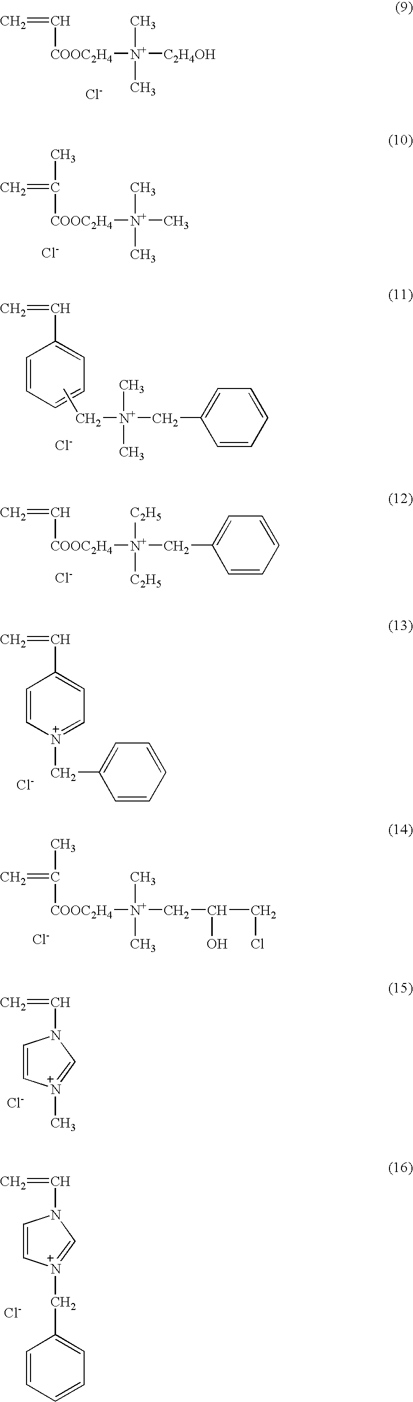

Monomers copolymerizable with the quaternary ammonium salts described above are compounds provided with an ethylenic unsaturated group, and listed are, for example, specific examples below.

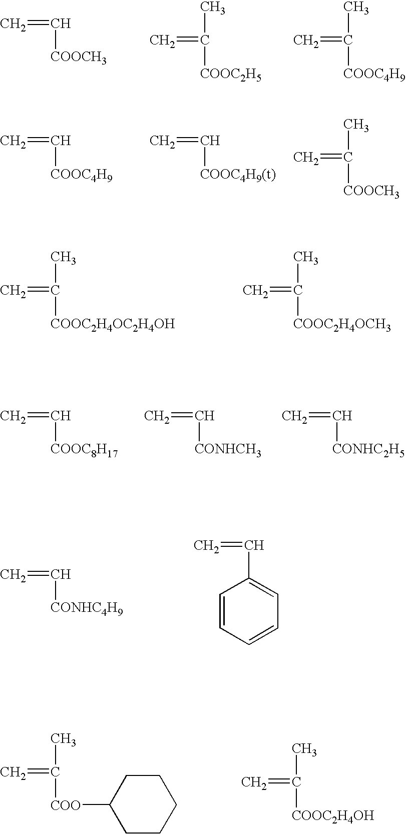

Particularly, in the case of a cationic polymer provided with a quaternary ammonium salt being a copolymer, a ratio of a cationic monomer is preferably not less than 10 mol %, more preferably not less than 20 mol % and specifically preferably not less than 30 mol %. The monomer provided with a quaternary ammonium salt is utilized alone or in combination of two or more types.

Listed below are cationic polymers utilized in this invention, however, the invention is not limited thereto.

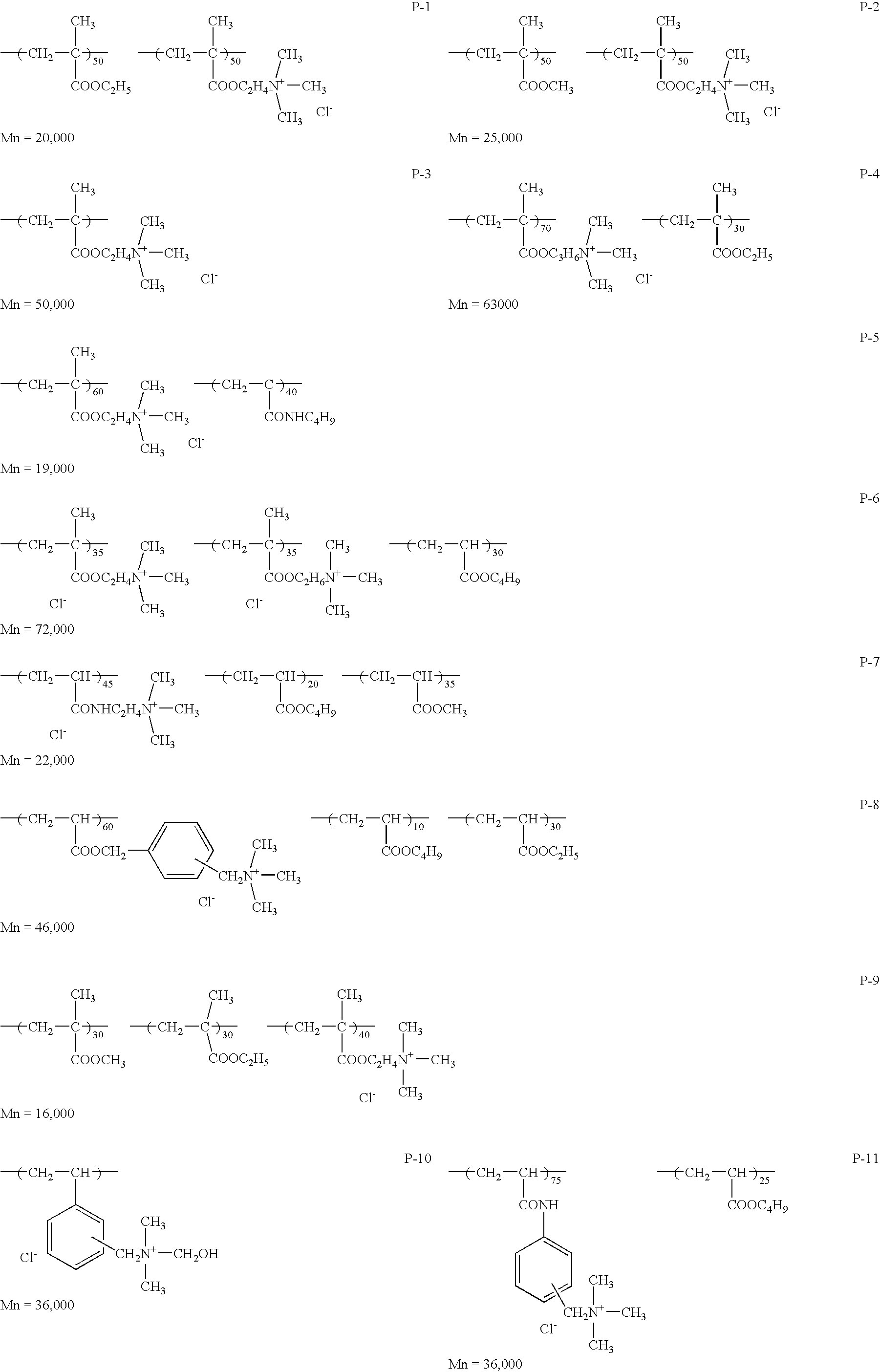

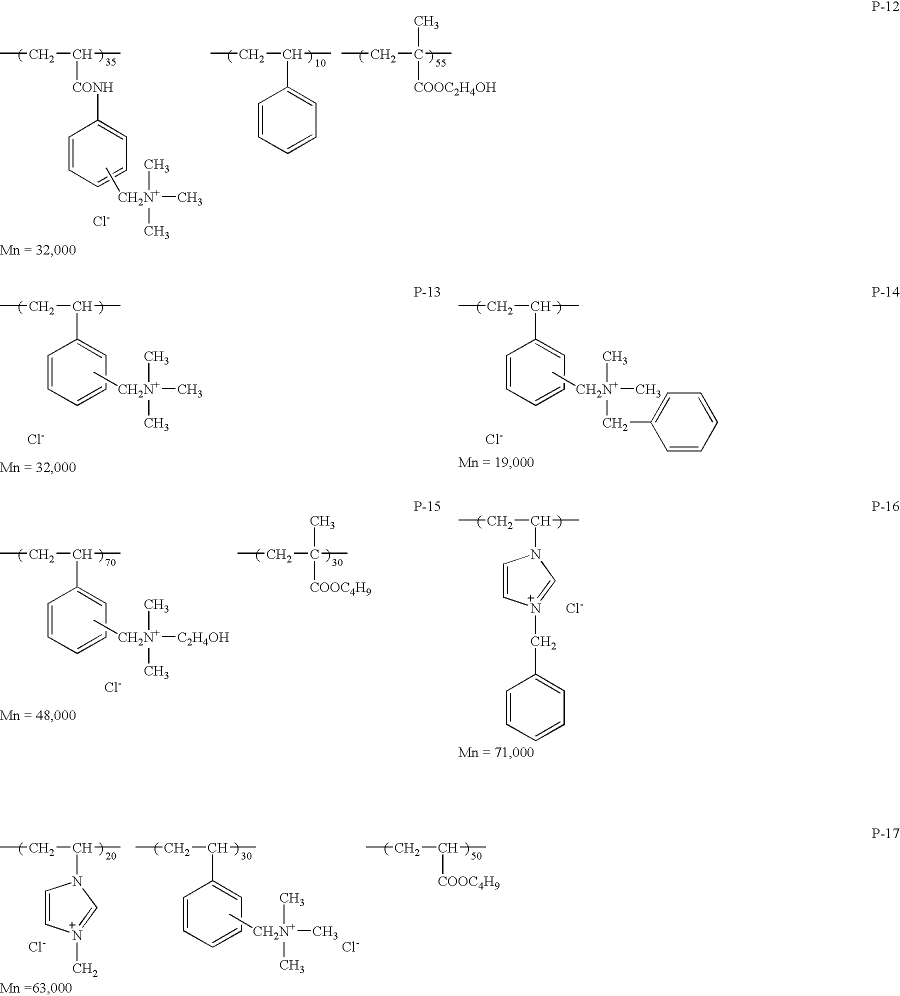

The cationic polymer provided with a quaternary ammonium salt described above generally has a high water-soluble property due to the quaternary ammonium salt. The polymer may not be dissolved sufficiently in water depending on a composition or a ratio of a copolymerized monomer containing no quaternary ammonium salt, however, utilized in this invention can be those provided being soluble in a mixed solvent of a water-miscible organic solvent and water.

Herein, a water-miscible organic solvent refers to alcohol series such as methanol, ethanol, isopropanol and n-propanol, glycol series such as ethylene glycol, diethylene glycol and glycerin, ester series such as ethyl acetate and propyl acetate, ketone series such as acetone and methylethyl ketone, and amide series such as N, N-dimethyl formamide, which can be dissolved in water generally at not less than 10%. The using amount of the organic solvent is preferably not more than that of water.

A cationic polymer utilized in this invention preferably has a number average molecular weight of not more than 100,000. Herein, a number average molecular weight is a converted polyethylene glycol value obtained by gel permeation chromatography.

In the case of a number average molecular weight being over 100,000, generation of aggregate is significant when a cationic polymer solution is added in a dispersion containing silica microparticles having anionic surfaces, further it is difficult to form a homogeneous dispersion even with a subsequent dispersion treatment, that is, a homogeneous dispersion solution is hardly prepared while many silica microparticles having a diameter of not less than 10 μm being contained. High gloss is hardly obtained when an ink-jet recording sheet is prepared by employing such a complex microparticle dispersion containing a cationic polymer and silica microparticles. A specifically preferable number average molecular weight is not more than 50,000. Further, the under limit of a number average molecular weight is generally not less than 2,000, with respect to water resistance of ink.

A ratio of silica microparticles and a cationic polymer according to this invention is variable depending on a type and a particle diameter of silica microparticles, or a type and a number average molecular weight of a cationic polymer. In this invention, said ratio is preferably 1/0.01-1/1, with respect to stabilizing the dispersion by converting the surface of silica microparticles into cationic.

Water-soluble polyvalent metallic compounds employed in this invention include water soluble salts of a metal selected from such as calcium, barium, manganese, copper, cobalt, nickel, aluminum, iron, zinc, zirconium, chromium, magnesium, tungsten and molybdenum. Specifically, listed are, for example, such as calcium acetate, calcium chloride, calcium formate, calcium sulfate, calcium butyrate, barium acetate, barium sulfate, barium phosphate, barium oxalate, naphthoresorcine barium carboxylate, barium butyrate, manganese chloride, manganese acetate, manganese formate dihydrate, manganese sulfate ammonium hexahydrate, copper (II) chloride, copper (II) chloride ammonium dihydrate, copper sulfate, copper (II) butyrate, copper oxalate, copper phthalate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, nickel sulfate ammonium hexahydrate, nickel amidosulfate hexahydrate, nickel sulfamate, nickel 2-ethylhexanate, aluminum sulfate, aluminum sulfite, aluminum thiosulfate, aluminum polychloride, aluminum nitrate nonahydrate, aluminum chloride hexahydrate, aluminum acetate, aluminum lactate, aluminum basic thioglycolate, iron (II) bromide, iron (II) chloride, iron (III) chloride, iron (II) sulfate, iron (III) sulfate, iron (III) citrate, iron (III) lactate trihydrate, iron (III) trioxalate triammonium trihydrate, zinc bromide, zinc chloride, zinc nitrate hexahydrate, zinc sulfate, zinc acetate, zinc lactate, zirconium acetate, zirconium chloride, zirconium chloride oxide octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium phosphorous wolframate, sodium tungsten oxalate, phospho-12-tangustate n hydrate, silico-12-tangustate 26 hydrate, molybdenum chloride and phospho-12-molybdate n-hydrate. These water-soluble polyvalent metallic compounds can be employed in combination of two or more types. In this invention, the water-solubility of a polyvalent metallic compound means being soluble not less than 1 weight % in water at 20° C.

Among the water-soluble polyvalent metallic compounds described above, preferable are compounds comprising aluminum or metals (for example, zirconium and titanium) of 4A group in the periodic table. Specifically preferable are water-soluble aluminum compounds. As water-soluble aluminum compounds, for example, commonly known are such as aluminum chloride or hydrates of thereof, aluminum sulfate and hydrates thereof and aluminum alum as inorganic salts. Further, known is a basic polyhydroxy aluminum compound as an inorganic type cationic polymer containing aluminum, which is preferably employed.

The aforesaid basic polyhydroxy aluminum compound is a water-soluble polyhydroxy aluminum, the main component of which stably contains a basic and polymeric polynuclear condensed ion represented by following general formula (1), (2) or (3) such as [Al₆(OH)₁₅]³⁺, [Al₈(OH)₂₀]⁴⁺, [Al₁₃(OH)₃₄]⁵⁺ and [Al₂₁(OH)₆₀]³⁺.

General formula (1) [Al₂(OH)ₙCl₆₋ₙ]ₘ

General formula (2) [Al(OH)₃]ₙAlCl₃

General formula (3) Alₙ(OH)ₘCl₍₃ₙ₋ₘ₎

wherein 0<m<3n, and m and n represent positive integers.

These compounds are easily available in various grades under the product names of such as aluminum polychloride (PAC) from Taki Chemicals Co., Ltd. as a water processing agent, aluminum polyhydroxide (Paho) from Asada Chemicals Co., Ltd., Purachem WT from Riken Green Co., Ltd. and also available from other manufacturers with a similar purpose.

The water-soluble polyvalent metallic compound described above is preferably added at 0.03-10.0 weight % and more preferably at 0.05-8.0 weight %, against silica microparticles.

Further, various types of additives can be added at the time of preparing the aforesaid dispersion. For example, appropriately utilized can be such as various nonionic or cationic surfactants (herein, an anionic surfactant is not preferred due to aggregate formation), a defoaming agent, nonionic hydrophilic polymers (such as polyvinyl alcohol, polyvinyl pyrrolidone, polyethylene oxide, polyacrylamide, various sugar series, gelatin and plurane), nonionic or cationic latex dispersions, water-miscible organic solvents (such as ethyl acetate, methanol, ethanol, isopropanol, n-propanol and acetone), inorganic salt series and a pH adjusting agent. Specifically, water-miscible organic solvents are preferred because formation of minute damps is depressed in the case of mixing wet-method silica microparticles, a cationic polymer and a water-soluble polyvalent metallic compound. Such a water-miscible organic solvent is utilized at 0.1-20.0 weight % and specifically preferably at 0.5-10.0 weight % in the dispersion. A pH at the time of preparing a cationic dispersion can be varied in a wide range depending on a type of silica microparticles, a type of cationic polymers and various additives, however, is generally 1-8 and specifically preferably 2-7.

Water-soluble resins according to this invention include, for example, water-soluble polymers such as gelatin (preferably acid processed gelatin), polyvinyl pyrrolidone (preferably having an average molecular weight of more than approximately 200,000), pullulan, polyvinyl alcohol or derivatives thereof, cation modified polyvinyl alcohol, polyethylene glycol (preferably having an average molecular weight of more than approximately 100,000), hydroxyethyl cellulose, dextran, dextrin and water-soluble polyvinyl butyral; these water-soluble polymers function as an hydrophilic binder in an ink receptive layer, and can be utilized alone or in combination of two or more types. A specifically preferable water-soluble resin is polyvinyl alcohol or cation modified polyvinyl alcohol.

Polyvinyl alcohols preferably employed in this invention have an average polymerization degree of 300-4000 and a film prepared from those having an average polymerization degree of not less than 1000 is specifically preferred with respect to brittleness. Further, a saponification degree of polyvinyl alcohol is preferably 70-100% and specifically preferably 80-100%.

Further, cation modified polyvinyl alcohol is obtained by saponification of a copolymer comprising, an ethylenic unsaturated monomer having a cationic group, and vinyl acetate. Ethylenic unsaturated monomers having a cationic group include, for example, such as trimethyl-(2-acrylamide-2,2-dimethylethyl)ammonium chloride, trimethyl-(3-acrylamide-3,3-dimethylpropyl)ammonium chloride, N-vinylimidazol, N-vinyl-2-methylimidazol, N-(3-dimethylaminopropyl)methacrylamide, hydroxyethyldimethyl (3-methacrylamide)ammonium chloride, trimethyl-(3-methacrylamidopropyl)ammonium chloride and N-(1,1-dimethyl-3-dimethylaminopropyl)acrylamide.

A ratio of monomer containing a cationic modifying group in cation modified polyvinyl alcohol is preferably 0.1-10.0 mol % and more preferably 0.2-5.0 mol %. Further, a polymerization degree of cation modified polyvinyl alcohol is generally 500-4000 and preferably 1000-4000. Further, a saponification degree of cation modified polyvinyl alcohol is generally 60-100 mol % and preferably 70-99 mol %.

In an ink-jet recording sheet according to this invention, a water-soluble resin according to this invention is preferably hardened with a hardener to achieve high gloss and high void ratio without deteriorating film brittleness. A hardener is a compound provided with a group which can react with said water-soluble resin, or a compound which accelerates a reaction between different groups of a water-soluble resin each other, and utilized by appropriate selection depending on types of a water-soluble resin.

Specific examples of hardeners utilized include, for example, such as epoxy type hardeners (such as diglycidyl ethylether, ethyleneglycol diglycidylether, 1,4-butanediol diglycidylether, 1,6-diglycidyl cyclohexane, N,N-diglycidyl-4-glycidyl oxyaniline, sorbitol polyglycidylether and glycerol polyglycidylether), aldehyde type hardeners (such as formaldehyde and glyoxal), active halogen type hardeners (such as 2,4-dichloro-4-hydroxy-1,3,5-s-triazine), active vinyl type hardeners (such as 1,3,5-trisacryloyl-hexahydro-s-triazine and bisvinylsulfonyl methyether), boric acid, salts thereof, borax and aluminum alum.

A hardener selected from boric acid, salts thereof or epoxy type hardeners is preferably employed when polyvinyl alcohol or cation modified polyvinyl alcohol is utilized as a water-soluble resin. Most preferable is a hardener selected from boric acid or salts thereof. Boric acid or salts thereof are oxyacids having a boron atom as the center atom and salts thereof, and specifically include orthoboric acid, diboric acid, metaboric acid, tetraboric acid, pentaboric acid, octaboric acid and salts thereof.

The using amount of a hardener varies depending on such as a type of a water-soluble resin, a type of a hardener, a type of silica microparticles and the ratio against a water-soluble resin, however, is generally 5-500 mg and preferably 10-300 mg, per gram of a water-soluble resin.

A hardener may be added in a void layer forming coating solution and/or other layers adjacent to the void layer forming coating solution, or said void layer forming coating solution may be coated on a support on which a coating solution containing a hardener having been coated in advance. Further, after a void layer forming coating solution is coated and dried, a hardener can be also supplied to a void layer by such as over coating of a hardener solution. It is preferred to supply a hardener at the same time as forming a void layer by adding the hardener in a void layer forming coating solution or a coating solution which forms a layer adjacent to said void layer.

The content ratio of a water-soluble resin to silica microparticles according to this invention is preferably 1/10-1/3 and specifically preferably 1/8-1/5. The ratio is necessary to be appropriately adjusted, because it varies the micro-void diameter.

The methods to add and mix a water-soluble resin into a dispersion include a method in which an aqueous solution of a water-soluble resin is added as a batch into a dispersion while stirring and a method in which a dispersion and a water-soluble resin are mixed continuously by use of a mixers such as a static mixer.

A water-soluble resin preferably utilized in this invention, specifically polyvinyl alcohol is generally has a poor solubility due to a high polymerization degree, which results in easy generation of so-called damps. Further, care has to be taken, because there are problems with respect to productivity and quality due to a long dissolution time. This problem can be solved by raising dissolving temperature to over 100° C., resulting in shortening of the dissolution time, as well as prevention of damp generation. Dissolving temperature is preferably not lower than 100° C. and not higher than 150° C. and more preferably not lower than 110° C. and not higher than 130° C. To raise the temperature too high may damage the structure, which results in a cause to lower the void ratio. To dissolve at higher than 100° C., employed can be heat sources such as electricity, oil and pressurized steam. Continuous dissolution is preferred with respect to productivity, and can be employed, for example, a dissolution system produced by Noritake Co., Ltd. When the dissolution temperature is too low, damps cannot be dissolved completely to cause cracks.

As supports of an ink-jet recording sheet of this invention, commonly known conventional paper supports, plastic supports (being transparent) and complex supports can be appropriately employed. A hydrophobic support, into which ink liquid does not penetrate, is preferred to obtain images having a higher density and vividness.

Transparent supports include, for example, films comprising materials such as a polyester type resin, a diacetate type resin, a triacetate type resin, an acrylic type resin, a polycarbonate type resin, a polyvinyl chloride type resin, a polyimide type resin, cellophane and celluloid; among them preferable are those resistant against heat radiation when utilized as OHP and specifically preferable is polyethylene terephthalate. The thickness of these supports is preferably 10-200 μm. A subbing layer commonly known is preferably provided on the ink receptive layer side and the backing layer side, with respect to adhesion of an ink receptive layer and a backing layer with the support. Further, as supports employed when transparency is not required, preferable are, for example, resin laminated paper (so called RC paper) provided with a polyolefin resin laminating layer added with a white pigment at least on the one side of the base paper, and so-called White-PET comprising a white pigment being added in polyethylene terephthalate.

A method to coat layers on a support can be appropriately selected from commonly known methods. In a preferable method, coating solutions are coated on a support followed by being dried. In this case, two or more layers can be coated simultaneously, and specifically preferable is simultaneous coating to complete coating of the all layers at one time. As a coating methods, preferably utilized is a roll coating method, a rod-bar coating method an air-knife coating method, a spray coating method, a curtain coating method or an extrusion coating method which employs a hopper described in U.S. Pat. No. 2,681,294. The coating speed is preferably not less than 150 m/min and more preferably not less than 200 m/min, with respect to productivity.

### EXAMPLES

In the following, this invention will be specifically explained in reference to examples, however, the embodiments of this invention is not limited thereto. Herein, “%” in examples represents absolutely dried weight % (a state without moisture) not otherwise mentioned.

### Example 1

(Preparation of Silica Powders No. 1-No. 4)

Sulfuric acid was added into a sodium silicate solution containing Na₂SO₄ while keeping the solution temperature in a range of 20-40° C. to make a neutralization rate of 40-55%. Successively, the solution was heated up to 80-95° C., ripened for 5-60 minutes, and sulfuric acid was added to this solution to make the pH of 3-4. Silica obtained above was filtered, washed and dried, and then pulverized. Prepared were silica powders No. 1-No. 4 having different specific surface areas and a sum volume of pores having a diameter of not more than 10 nm by adjusting the Na₂SO₄ concentration, reaction temperature, SiO₂ concentration, neutralization rate and addition duration of sulfuric acid. The specific surface area and a sum volume of pores having a diameter of not more than 10 nm of each silica powder are shown in Table 1.

TABLE 1

| Silica | Specific | Sum volume of pores having |
|---|---|---|
| Powder | surface | a diameter of not more than |
| No. | area (m²/g) | 10 nm (ml/g) |
| 1 | 250 | 0.7 |
| 2 | 250 | 0.25 |
| 3 | 250 | 0.14 |
| 4 | 205 | 0.22 |

(Preparation of Silica Microparticle Dispersions No. 1-No. 10)

Preliminary dispersions were continuously prepared by continuously dispersing each silica powder No. 1-No. 4, prepared above with a water-based medium, by use of a continuous pin mixer (Flow Jet Mixer 300-type, produced by Hunken Pawtech Co., Ltd.) and a high speed rotary continuous homogenizer (Flow Fine Mill FM25, produced by Taiyo Kiko Co., Ltd.). The aforesaid water-based medium refers to water containing boric acid and P-9 as a cationic polymer. Boric acid was added at 2.7% and P-9 at 7%, based on the weight of silica. Herein, the concentration of silica in the preliminary dispersion was set to 30%.

Next, the preliminary dispersion was dispersed with a sand mill homogenizer (RL-125, produced by Ashizawa Co., Ltd.; hereinafter abbreviated as SM), followed by being subjected to a filtering treatment. Silica microparticles No. 1-No. 10 having different values of Y+17×logₑ(X) were prepared by varying a bead diameter of SM, a circumferential speed, a retention time, a number of pass and a number of filtering, and a bore diameter. The silica powders utilized and the values of Y+17×logₑ(X) are described in Table 2. Wherein, the value of Y+17×logₑ(X) is represented by Z, for convenience, in Tables 2 and 3.

TABLE 2

| Silica | | |
|---|---|---|
| microparticles | Silica powder | |
| dispersion No. | No. utilized | Z |
| 1 | 1 | 100 |
| 2 | 1 | 160 |
| 3 | 1 | 200 |
| 4 | 1 | 300 |
| 5 | 1 | 550 |
| 6 | 2 | 100 |
| 7 | 2 | 200 |
| 8 | 3 | 100 |
| 9 | 3 | 200 |
| 10 | 4 | 200 |

(Preparation of Silica Microparticle Dispersions No. 11-No. 12)

A silica dispersion (referred to as silica microparticle dispersion No. 11) was prepared in a similar manner to above, by changing the silica powder to Nipsil HD-2 (manufactured by Nippon Silica Industrial Co., Ltd., a specific surface area being 280 m²/g, a sum volume of pores having a diameter of not more than 10 nm being 0.65 ml/g) (refered to as silica powder No. 5). The value of Y+17×logₑ(X) of silica microparticles No. 11 was 230.

Next, a silica dispersion solution (referred to as silica microparticle dispersion No.12) was prepared in a similar manner to above, except that the silica powder was changed to X-37 (manufactured by Tokuyama Corp., a specific surface area being 275 m²/g, a sum volume of pores having a diameter of not more than 10 nm being 0.7 ml/g) (referred to as silica powder No. 6). The value of Y+17×logₑ(X) of silica microparticles No. 12 was 210.

(Preparation of Ink-Jet Recording Sheets No. 1-No. 12)

A polyvinyl alcohol solution (10%, PVA 235, manufactured by Kuraray Co., Ltd.) was mixed into each silica microparticle dispersion prepared above to prepare a coating solution. The weight ratio of silica to polyvinyl alcohol was 6.5/1, and the concentration of silica in the coating solution was set to 16 weight %.

The above each coating solution was coated on a paper support (having a thickness of 220 μm, and 13 weight of anatase type titanium oxide was contained based on polyethylene in the polyethylene on the ink receptive layer side), the both surface of which were laminated with polyethylene, to make a coating amount of silica of 13 g/m². Coating was performed by means of multi-layer coating employing a curtain coater. After having been kept in a cooling zone maintained at 0° C. for 20 seconds immediately after coating, the coated layers were dried successively by the air of 25° C. (a relative humidity of 15%) for 60 seconds, by the air of 45° C. (a relative humidity of 25%) for 60 seconds and by the air of 50° C. (a relative humidity of 25%) for 60 seconds, then rehumidified under environment of 20-25° C. and a relative humidity of 40-60% relative humidity for 2 minutes. The coating speed was 300 m/min.

(Evaluation of Ink-Jet Recording Sheet)

The following evaluations were performed with respect to ink-jet recording sheets No. 1-No. 12 prepared above.

(Micro-Void Radius in Ink Receptive Layer)

It was measured by use of Micrometrix Poresizer 9320 (produced by Shimadzu Corporation).

(Sum Volume of Micro-Voids in Ink Receptive Layer)

Ink-jet recording sheet was cut into a A4 size, the weight of which was measured (said weight is designated as A), then it was immersed in ion-exchanged water at 25° C. for 1 minute, and moisture on the surface was wiped off to measure the weight (said weight is designated as B). The value A-B was determined, and the converted value per unit area (m² of an ink-jet recording sheet) is designated as a sum volume of micro-voids (ml/m²). Strictly speaking, it is necessary to take an air weight originally contained in micro voids and a specific gravity of ion exchanged water at 25° C. into consideration. However, since these effects were negligibly small to be neglected, B-A was considered to be a sum volume of micro-voids in an ink receptive layer of an ink-jet recording paper of A4 size when converting a weight into a volume.

(Glossiness)

Glossiness at 75 degree was measured by use of Variable Degree Photometer (VGS-1001DP), produced by Nippon Denshoku Kogyo.

(Ink Absorptive Property)

Magenta solid was printed by use of Ink-jet Printer PM750C, produced by Seiko-Epson Co., Ltd., and generation of spottiness in the image portion was evaluated visually. Spottiness generation becomes frequent when an ink absorptive rate is slow. The evaluation ranks were as follows.

A: No spottiness was observed.

B: A few spottiness was observed, however, there are no practical problem.

C: Spottiness observed was problematic in practical use.

(Maximum Density)

Magenta solid was printed by use of Ink-jet Printer PM750C, produced by Seiko-Epson Co., Ltd., and the maximum reflective density was measured.

The characteristic values of each sample are shown in Table 3, and result of glossiness, a maximum density and an ink absorptive property are shown in Table 4.

TABLE 3

| | Silica powder utilized | | | | | Ink receptive layer | | |
|---|---|---|---|---|---|---|---|---|
| | | | Sum volume of | Silica | | Peak of | | |
| | | | micro-voids | microparticles | | distribution | Total | |
| Ink-jet | Silica | Specific | having a | dispersion | | curve | micro- | |
| recording | powder | surface | diameter of | Silica | | of micro- | void | |
| sheet | No. | area | not more than | microparticles | | void radii | volume | |
| No. | utilized | (m²/g) | 10 μm (ml/g) | dispersion No. | z | (nm) | (ml/m²) | Remarks |
| 1 | 1 | 250 | 0.7 | 1 | 100 | 8 | 13.5 | Comp. |
| 2 | 1 | 250 | 0.7 | 2 | 160 | 18 | 15.3 | Inv. |
| 3 | 1 | 250 | 0.7 | 3 | 200 | 25 | 17.0 | Inv. |
| 4 | 1 | 250 | 0.7 | 4 | 300 | 37 | 17.6 | Inv. |
| 5 | 1 | 250 | 0.7 | 5 | 550 | 53 | 17.9 | Comp. |
| 6 | 2 | 250 | 0.25 | 6 | 100 | 8 | 13.0 | Comp. |
| 7 | 2 | 250 | 0.25 | 7 | 200 | 28 | 15.9 | Inv. |
| 8 | 3 | 250 | 0.14 | 8 | 100 | 9 | 11.0 | Comp. |
| 9 | 3 | 250 | 0.14 | 9 | 200 | 28 | 12.5 | Comp. |
| 10 | 4 | 205 | 0.22 | 10 | 200 | 30 | 15.1 | Inv. |
| 11 | 5 | 280 | 0.65 | 11 | 230 | 28 | 16.9 | Inv. |
| 12 | 6 | 275 | 0.7 | 12 | 210 | 27 | 16.9 | Inv. |

Comp.; Comparison
Inv.; Invention

TABLE 4

| Ink-jet | | | Ink | |
|---|---|---|---|---|
| recording | Glossiness | Maximum | absorptive | |
| sheet No. | (%) | density | property | Remarks |
| 1 | 60 | 2.08 | C | Comparison |
| 2 | 60 | 2.09 | A | Invention |
| 3 | 58 | 2.05 | A | Invention |
| 4 | 55 | 2.00 | A | Invention |
| 5 | 40 | 1.65 | A | Comparison |
| 6 | 59 | 2.01 | C | Comparison |
| 7 | 55 | 2.02 | A | Invention |
| 8 | 58 | 1.55 | C | Comparison |
| 9 | 54 | 1.54 | C | Comparison |
| 10 | 56 | 2.00 | A | Invention |
| 11 | 57 | 2.07 | A | Invention |
| 12 | 58 | 2.09 | A | Invention |

It is clear from Table 4 that an ink-jet recording sheet of this invention is provided with an excellent ink receptive property, a high printing density and a high glossiness.

This invention can provide an ink-jet recording sheet having an excellent ink absorptive property, a high printing density and a high glossiness.

### Example 2

(Preparation of Dispersion 1)

Gas-phase method silica available on the market (QS-102, manufactured by Tokuyama Corp.) was rehumidified by being kept in a vessel conditioned at a relative humidity of 10% for 3 days. IR ratio of the silica after having been rehumidified was determined by the method described in the aforesaid detailed explanation to be 2.43.

The silica after having been rehumidified was dispersed continuously by use of a continuous pin mixer (Flow Jet Mixer 300-type, produced by Hunken Pawtech Co., Ltd., hereinafter referred to as FJM). Thereafter, the resulting dispersion was dispersed further by a high-speed continuous homogenizer (Flow Fine Mill FM25, produced by Taiyo Kikosha Co., Ltd., hereinafter referred to as FM) to prepare a preliminary dispersion. The circumferential speed of FJM and FM were 30 m/sec. Each additive is contained in the aforesaid water-based medium so as to make the ratio against the weight of silica as follows.

| | |
|---|---|
| P-9 | 12% |
| Boric acid | 1.6% |
| Borax | 1.6% |
| Ethanol | 7% |

The preliminary dispersion prepared above was dispersed by use of a sand mill homogenizer (RL-125, produced by Ashizawa Co., Ltd.). The dispersion conditions of the sand mill were 0.5 mm zirconia beads, a filling ratio of 80%, a circumferential speed of 7 m/sec, a retention time of 5 minutes and a one pass treatment.

Herein, silica concentrations in dispersions at preliminary dispersion process and a main dispersion process are set at the controllable upper limit which was determined after a load on a homogenizer and possibility of liquid transportation having studied. The concentration of dispersion 1 was set to 15%.

Further, an average secondary particle diameter of silica microparticles was determined by the method detailed above to be 231 nm. When Z is defined as: Z=Y+logₑ(X), the value of Z was 550.

(Preparation of Dispersion 2)

Dispersion 2 was prepared in a similar manner to dispersion 1, except that QS-102 was rehumidified by being kept in a vessel conditioned at a relative humidity of 60% for 7 days, and a silica concentration in the dispersion was set to 19%. At this time, an IR ratio of silica after having been rehumidified was 1.37. Further, a dispersed particle diameter was 228 nm. The value of Z was 300.

(Preparation of Dispersion 3)

Dispersion 3 was prepared in a similar manner to dispersion 1, except that QS-102 was rehumidified by being kept in a vessel conditioned at a relative humidity of 60% for 30 days, and a silica concentration in the dispersion was set to 23%. At this time, an IR ratio of silica after having been rehumidified was 0.95. Further, a dispersed particle diameter was 208 nm. The value of Z was 210.

(Preparation of Dispersion 4)

QS-102 was rehumidified by being kept in a vessel conditioned at a relative humidity of 60% for 7 days, and then seal-pressed to make a bulk density of 90 g/L starting from 50 g/L which was a result of aeration, which resulted in an IR ratio of 0.71. Silica dispersion 4 was prepared in a similar manner to dispersion 3, except that a silica concentration in the dispersion was set to 25%. At this time, a dispersed particle diameter was 225 nm. The value of Z was 210.

(Preparation of Dispersion 5)

Wet-method silica available on the market (Trademark T-32, manufactured by Tokuyama Corp., precipitation-method silica having a specific surface area of 220 g/m² and an average agglomerate particle diameter of 1.5 μm) was rehumidified by being kept in a vessel conditioned at a relative humidity of 40% for 3 days. An IR ratio of silica after having been rehumidified was 0.03. Dispersion 5 was prepared in a similar manner to dispersion 1, except that the silica having been rehumidified was mixed with a water-based medium to make a ratio of each additive per silica weight of as follows:

| | |
|---|---|
| P-9 | 4% |
| Boric acid | 2.7% |

and a silica concentration in the dispersion was set to 30%. At this time, a dispersed particle diameter was 192 nm. The value of Z was 160.

(Preparation of Dispersion 6)

Wet-method silica available on the market (Trademark X-37, manufactured by Tokuyama Corp., precipitation-method silica having a specific surface area of 275 g/m² and an average agglomerate particle diameter of 2.6 μm) was rehumidified by being kept in a vessel conditioned at a relative humidity of 40% for 3 days. An IR ratio of silica having been rehumidified was 0.17. Dispersion 6 was prepared in a similar manner to dispersion 1, except that the silica having been rehumidified was mixed with a water-based medium to make a ratio of each additive per silica weight of as follows:

| | |
|---|---|
| P-9 | 12% |
| Boric acid | 2.7% |

and a silica concentration in the dispersion was set to 30%. At this time, a dispersed particle diameter was 213 nm. The value of Z was 160.

(Preparation of Dispersion 5)

Wet-method silica available on the market (Trademark X-37B, manufactured by Tokuyama Corp., precipitation-method silica having a specific surface area of 287 g/m² and an average agglomerate particle diameter of 3.7 μm) was rehumidified by being kept in a vessel conditioned at a relative humidity of 40% for 3 days. An IR ratio of silica having been rehumidified was 0.25. Dispersion 7 was prepared in a similar manner to dispersion 1, except that the silica having been rehumidified was mixed with a water-based medium to make a ratio of each additive per silica weight of as follows:

| | |
|---|---|
| P-9 | 12% |
| Boric acid | 2.7% |

and a silica concentration in the dispersion was set to 23%. At this time, a dispersed particle diameter was 360 nm. The value of Z was 500.

(Preparation of Coating Solutions 1-7 and Recording Sheet 101-107)

A polyvinyl alcohol solution (10% PVA 235, manufactured by Kuraray Co., Ltd.) was mixed into each of dispersions 1-7 so as to make a solid weight ratio of silica/polyvinyl alcohol of 6 to prepare coating solutions 1-7. The coating solution was adjusted to have a temperature of 40° C. and diluted with water to have a viscosity enabling coating. Silica concentrations of coating solutions 101-107 are shown in Table 5.

Thereafter, coating solutions 1-7 were supplied to a slide-hopper coater to be coated on a support the both surface of which were laminated with polyethylene so as to make a coating amount of silica of 17 g/m², and after having been cooled in a cooling zone kept at 0° C. for 20 seconds immediately after coating, the coated layers were successively dried with the air of 25° C. (a relative humidity of 15%), the air of 45° C. (a relative humidity of 25%) and with the air of 50° C. (a relative humidity of 25%), followed by being rehumidified under environment of 20-25° C. and a relative humidity of 40-70% for 2 minutes. In this manner, recording sheets 101-107 were prepared from coating solutions 1-7.

The following evaluations were performed with respect to recording sheets 101-107 prepared above.

(Cracking)

A number of cracks per 0.3 m² of the coated surface were counted visually. A number of cracks not more than 10 generally cause no problem in practical use.

(Ink Overflow)

Magenta solid was printed employing Ink-jet Printer PM 750C manufactured by Seiko Epson Co., Ltd., and a state of ink overflow was visually observed.

A: No overflow is observed.

B: A slight overflow is observed, however, there is no problem in practical use.

C: There are problems in practical use.

The evaluation was performed according to the above criteria. This evaluation is a measure of an ink absorption volume (a void volume).

(Glossiness)

Glossiness at 75 degree was measured employing a Variable Degree Photometer produced by Nippon Denshoku Kogyo Co., Ltd. It is effective as a photo-like recording sheet when this value is over 45%.

Results obtained above are shown in Table 1.

TABLE 5

| | | | | | Silica | | | | |
|---|---|---|---|---|---|---|---|---|---|
| | | | | Silica | concentration | | | | |
| | | | Dispersed | concentration | of | | | | |
| Recording | | | particle | of | coating | | | | |
| sheet | IR | | diameter | dispersion | solution | | Ink | Glossiness | |
| No. | ratio | Z* | (nm) | (%) | (%) | Cracks | overflow | (%) | Remarks |
| 101 | 2.43 | 550 | 231 | 15 | 10 | 40 | B | 30 | Comp. |
| 102 | 1.37 | 300 | 228 | 19 | 14 | 15 | B | 40 | Inv. |
| 103 | 0.95 | 210 | 208 | 23 | 18 | 9 | A | 55 | Inv. |
| 104 | 0.71 | 210 | 225 | 25 | 20 | 3 | A | 60 | Inv. |
| 105 | 0.03 | 160 | 192 | 30 | 26 | 4 | A | 62 | Inv. |
| 106 | 0.17 | 160 | 213 | 27 | 23 | 8 | A | 54 | Inv. |
| 107 | 0.25 | 500 | 360 | 23 | 18 | 10 | A | 45 | Inv. |

*Z = Y + 17 × logₑ(X);
Comp.: Comparison;
Inv.: Invention

It is clear from Table 5 that samples of this invention are recording sheets having a high productivity, an excellent ink absorption property as well as a high gloss.

This invention can provide an ink-jet recording sheet which exhibits a high productivity, an excellent ink absorption property, depressed cracks in a film as well as a high gloss, and a manufacturing method thereof.

What is claimed is:

1. An ink-jet recording sheet comprising a support having thereon an ink receptive layer containing silica microparticles and a water-soluble resin,
wherein the ink receptive layer is a porous layer having ink receptive voids with a peak value in a distribution curve of radii of the ink receptive voids of 10 to 50 nm; and the silica microparticles are prepared by pulverizing a silica powder, two parameters X and Y of the silica microparticles satisfying the following relationship:
150<Y+17×logₑ(X)<500,
X being a number of silica microparticles having a diameter of not less than 10 μm contained per gram of the silica microparticles; and
Y being an average particle diameter of the silica microparticles measured in nm.

2. The ink-jet recording sheet of claim 1, wherein the silica powder has a pore volume of not less than 0.2 ml/g, the pore volume being defined as a sum of volumes of pores in the silica powder, each pore having a diameter of not more than 10 nm.

3. The ink-jet recording sheet of claim 1, wherein a specific surface area of the silica powder is not less than 200 m²/g, and a total volume of the ink receptive voids in the ink receptive layer is not less than 15 ml/m².

4. The ink-jet recording sheet of claim 1, wherein the silica microparticles has a ratio of isolated silanol groups of less than 1.0.

5. The ink-jet recording sheet of claim 4, wherein an average particle diameter of primary particles of the silica microparticles is 120 to 350 nm.

6. The ink-jet recording sheet of claim 4, wherein the silica microparticles are made by a wet method; a specific surface area of the silica microparticles measured with a BET method is 150 to 350 m²/g; and an average particle diameter of secondary particles of the silica microparticles measured with a Coulter counter is 1.0 to 2.8 μm.

7. The ink-jet recording sheet of claim 4, wherein a surface glossiness of the ink-jet recording sheet measured at 75 degree is 45 to 80%.

8. The ink-jet recording sheet of claim 7, wherein the ink receptive layer is prepared using a method comprising the step of:
coating an ink receptive coating composition on the support to form the ink receptive layer; and
drying the coated ink receptive layer without a post-treatment so as to increase a surface glossiness.

9. A method of preparing an ink-jet recording sheet of claim 1, comprising the steps of:
(i) dispersing the silica microparticles and an aqueous media to obtain a silica dispersion;
(ii) adding an additive to the silica dispersion to make a coating composition;
(iii) coating the coating composition onto a support; to obtain an ink receptive layer; and
(iv) drying the ink receptive layer,
wherein the step (i) comprises:
(i-1) a first dispersing step to obtain a preliminary silica dispersion; and
(i-2) a second dispersing step to obtain the silica dispersion by further dispersing the preliminary silica dispersion.

10. The preparation method of claim 9, wherein the first dispersing step (i-1) is conducted by:
continuously introducing the silica microparticles and an aqueous media into a first dispersing apparatus and dispersing so as to obtain a preliminary silica dispersion; and
continuously ejecting the preliminary silica dispersion from the first dispersing apparatus,
the second dispersing step (i-2) is conducted by:
continuously introducing the preliminary silica dispersion into a second dispersing apparatus so as to further disperse the preliminary silica dispersion; and
continuously ejecting the silica dispersion from the second dispersing apparatus.

11. A method of preparing an ink-jet recording sheet of claim 1, wherein an average particle diameter of the silica microparticles is 120 to 350 nm.

12. A method of preparing an ink-jet recording sheet of claim 1, wherein the silica microparticles have a specific surface area measured with a BET method of 150 to 350 m²/g and an average particle diameter of secondary particles of the silica microparticles is 1.0 to 2.8 μm measured with a Coulter counter.

13. A method of preparing an ink-jet recording sheet of claim 1, wherein a surface glossiness of the ink-jet recording sheet measured at 75 degree is 45 to 80%.

14. A method of preparing an ink-jet recording sheet of claim 1, wherein in the drying step (iv), drying the ink receptive layer is carried out without a post-treatment which increases a surface glossiness of the ink-jet recording sheet.
